(19) United States
(12) Patent Application Publication
(10) Pub. No.: US 2008/0314458 A1
(43) Pub. Date: Dec. 25, 2008

(54) Method and Device for Regulating a Pressure and/or a Volume Flow of a Fluid

(76) Inventors: Uwe Iben, Gerlingen (DE); Klaus Habr, Marktheidenfeld (DE)

Correspondence Address: KENYON & KENYON LLP, ONE BROADWAY, NEW YORK, NY, 10004, US

(21) Appl. No.: 11/884,178

(22) PCT Filed: Dec. 6, 2005
(86) PCT No.: PCT/EP05/56512

§ 371 Date: May 13, 2008

(30) Foreign Application Priority Data
Feb. 9, 2005 (DE) 10 2005 005 762.4

(51) Int. Cl. F16K 31/12; F17D 3/00

(52) U.S. Cl. 137/491; 137/12

(57) ABSTRACT

A device for regulating a pressure and/or a volume flow of a fluid, including a cavitation chamber having a ram device, to generate a ram pressure region, and having at least one outlet orifice for a discharge of the fluid from the cavitation chamber, at least one cavitation region being able to be generated in the cavitation chamber, and the outlet orifice being situated so that the fluid flows between the cavitation region and the ram pressure region to the outlet orifice. Also described is a method for regulating a pressure and/or a volume flow.

### FIELD OF THE INVENTION

The present invention relates to a pressure-regulating valve for regulating a pressure and/or a volume flow of a fluid. The present invention also relates to a method for regulating a pressure and/or a volume flow.

### BACKGROUND INFORMATION

Pressure-regulating valves and methods for regulating a pressure are known from the related art in the most varied designs. The known pressure-regulating valves, in this context, use as the operating principle a controlled or regulated change in the geometry relevant to the flow. This is implemented by using a closing member, such as a control plunger, a ball-cone seat configuration or a slide valve. It is common to all the known pressure-regulating valves, in this instance, that the closing member is moved to carry out the regulating process. The size of the passage that is cleared is determined as a function of the path covered by the closing member, and, with that, the pressure and the volume flow. Beside the moving closing members and especially in response to sealing problems that occur at high pressures, in the case of the known pressure-regulating valves there may also come about undesired pressure pulsations, particularly upon opening and closing the pressure-regulating valve.

### SUMMARY OF THE INVENTION

By contrast, the device according to the present invention, for regulating a pressure and/or a volume flow of a fluid, has the advantage that it has no moving parts, such as a closing member or the like. Because of that, a maintenance-free pressure-regulating device can be provided, which has a long service life. In addition, the device according to the present invention has no restrictions with respect to its dynamics, for regulating a pressure and/or a volume flow. The occurrence of pressure pulsations during a regulating process is thereby prevented. In this context, the device according to the present invention uses the cavitation phenomenon as its operating principle, and can do without a moving closing element. Consequently, a two-phase fluid, that is, a fluid having a liquid and gaseous phase, is deliberately generated in a cavitation chamber that is used for the regulation of the pressure and/or the volume flow. In the cavitation chamber there is at least one outlet orifice, in this instance, the fluid to be regulated flowing between the deliberately generated cavitation area and a pressure area to the outlet orifice. In this context, the regulating process can be performed by changing the ram pressure region and/or changing the cavitation region.

The cavitation chamber may be situated behind a throttle, in the flow direction. The throttle may be modifiable with respect to its cross section. A base regulating pressure can thereby be set by changing the throttle cross section.

The ram device in the cavitation chamber may be developed as a domed region, and especially as a spherical segment. This enables a symmetrical, conically shaped ram pressure area to be produced.

A free jet of the fluid may be directed to the middle of the ram area.

According to one exemplary embodiment of the present invention, the cavitation region includes at least one eddy having a shear layer cavitation. In one especially exemplary version, the cavitation region includes two eddies, which are particularly situated symmetrically to the free jet of the fluid.

A plurality of outlet orifices is provided in the cavitation chamber, which are particularly situated symmetrically to the free jet and/or symmetrically to the ram device, in a exemplary version.

The method, according to the present invention, for regulating a pressure and/or a volume flow of a fluid uses the cavitation phenomenon for the regulation, and intentionally generates a cavitation. In the course of doing this, the fluid to be regulated is conveyed to a cavitation chamber in such a way that a cavitation region and a ram pressure region are generated in the cavitation chamber. An outlet orifice is provided in the cavitation chamber, the fluid flowing between the cavitation region and the ram pressure region to the outlet orifice. The method according to the present invention carries out the regulating procedure by changing the position of the cavitation region and/or the ram pressure region, in this instance, and/or by an enlargement of or a diminution in the cavitation region and/or the ram pressure region. As a result, one may do without a moving closing member as is used in the related art, and a higher regulating frequency is made possible.

The method according to the present invention preferably provides a decreasing flow loss while using an increasing volume flow. The method according to the present invention achieves this by enlarging the ram pressure region because of the enlarging of the volume flow, and this leads to a shift of the cavitation region. The shift of the cavitation region is performed, in this context, in such a way that the cavitation region is displaced somewhat from an outlet orifice in the cavitation chamber. The fluid flowing to the outlet orifice can thereby flow with lesser obstruction through the cavitation region to the outlet orifice, so that the flow losses are reduced, and a greater volume flow discharges from the outlet orifice.

It is particularly exemplary to set a base regulating pressure using an adjustable throttle that is situated before the cavitation chamber, in the flow direction.

It is also exemplary that two cavitation regions be generated in the cavitation chamber, which are particularly developed as eddies, and are particularly symmetrical to a free jet.

The exemplary embodiment and/or exemplary method of the present invention may be used particularly in vehicles. In this connection, its use in fuel injection systems is possible, such as in common rail systems or direct injection systems. Furthermore, the exemplary embodiment and/or exemplary method of the present invention can be used in hydraulic applications in vehicles, such as in braking systems. In this connection, on the one hand, a hydraulic regulating concept can be implemented, and, on the other hand, pulsation damping can be put into effect.

### BRIEF DESCRIPTION OF THE DRAWINGS

FIG. 1 shows a schematic sectional view of a device for regulating a pressure and/or a volume flow according to a first exemplary embodiment of the present invention in the case of a first volume flow.

FIG. 2 shows a schematic sectional view of the device shown in FIG. 1, in the case of a second volume flow that is greater than the first volume flow.

FIG. 3 shows a diagram which shows a characteristic curve of a pressure regulation by a device according to the present invention.

### DETAILED DESCRIPTION

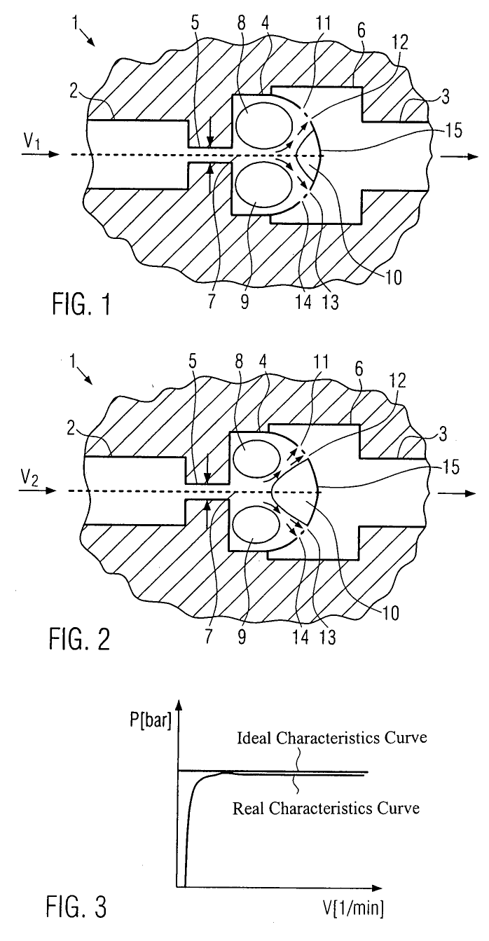

With reference to FIGS. 1 through 3, an exemplary embodiment is described in detail below. FIG. 1 shows a device 1 for regulating a pressure and/or a volume flow V₁ of a fluid. Device 1 includes a supply line 2, a discharge line 3 and a cavitation chamber 4. An adjustable throttle 5 is situated before cavitation chamber 4, in the direction of flow. The arrows at throttle 5 are supposed to indicate a changeable throttle cross section. Downstream in cavitation chamber 4, there is a transition region 6 which turns into discharge line 3.

Cavitation chamber 4 includes a plurality of discharge orifices 11, 12, 13, 14. Discharge orifices 11, 12, 13, 14 are situated symmetrically with respect to a free jet 7. Free jet 7 develops particularly after the cross sectional constriction made available by throttle 5. Moreover, cavitation chamber 4 includes a ram device 15, which is a baffle plate in this exemplary embodiment. Ram device 15 in this case has an essentially spherical segment shape, and is also developed symmetrically with respect to free jet 7. Consequently, free jet 7 reaches into the middle of ram device 15, as shown in FIG. 1. Because of this, a ram pressure region 10 is developed in cavitation chamber 4. Ram pressure region 10 is also developed symmetrically to free jet 7, in this instance, and has an essentially conical shape. The discharge orifices are also situated symmetrically to ram device 15.

Because of the flow conditions in cavitation chamber 4, a first cavitation region 8 and a second cavitation region 9 also develop in cavitation chamber 4. The two cavitation regions 8, 9 are also developed symmetrically with respect to free jet 7. Cavitation regions 8, 9 are two developing eddies which cause a shear layer cavitation. Because of that, a two-phase mixture is partially present in cavitation chamber 4. We should note at this point that, in a two-phase flow, the fluidic losses are substantially higher than in a one-phase flow.

In FIG. 1, the flow relationships are shown schematically by the little arrows drawn in in cavitation chamber 4. As can be seen in FIG. 1, ram pressure region 10 has the effect that the fluid flows between first cavitation region 8 and ram pressure region 10 to outlet orifice 12, and flows between second cavitation region 9 and ram pressure region 10 to outlet orifice 13. In this context, outlet orifices 11 and 14 are partially covered by first cavitation region 8 and second cavitation region 9, so that hardly any fluid discharges through these two outlet orifices 11, 14 into transitional region 6.

Consequently, using device 1 according to the exemplary embodiment and/or exemplary method of the present invention, a pressure and/or volume flow of the liquid supplied is regulated by a deliberate generation of cavitation in cavitation chamber 4. Because of variable throttle 5, a base regulating pressure can further be set in this context. Furthermore, a cross sectional change in the region of throttle 5 also has an effect on the size of the two cavitation regions 8, 9, as well as well as on ram pressure region 10. Hereby, too, a regulation of the fluid can be carried out. The device according to the exemplary embodiment and/or exemplary method of the present invention can therefore do without moving parts, such as closing elements or the like, in this context.

FIG. 2 shows the device shown in FIG. 1, the difference being that a volume flow V₂ is supplied, which is clearly greater than volume flow V₁ shown in FIG. 1. Because of greater volume flow V₂, a larger ram pressure region 10 develops before ram device 15 in cavitation chamber 4. First cavitation region 8 and second cavitation region 9 are displaced somewhat, thereby, counter to the flow direction, in the direction towards throttle 5. Furthermore, the two cavitation regions 8, 9 are somewhat smaller than in the case of a lower volume flow. Because of this measure, the two cavitation regions 8, 9 are also displaced from outlet orifices 11 and 14, so that the fluid is not only able to discharge through outlet orifices 12 and 13, as in the first exemplary embodiment, but can discharge through all four outlet orifices 11, 12, 13, 14. This is made clear in FIG. 2 by the little arrows shown in cavitation chamber 4. Consequently, by an increased volume flow (V₂), a flow loss in the cavitation chamber can be reduced, whereby a pressure regulating valve function and a volume flow change function can also be made available.

If volume flow V₂ were increased even further, ram pressure region 10 could become so big, in this instance, that the two outlet orifices 12, 13 that are situated adjacent to ram pressure region 10 could be covered partially or completely by the ram pressure region. An additional regulating function of device 1 with respect to pressure and/or volume flow can take place too, because of this.

FIG. 3 shows a diagram of pressure p plotted against volume flow V. An ideal characteristics curve of a pressure regulating valve and a real characteristics curve of a device 1 according to the exemplary embodiment and/or exemplary method of the present invention are shown in this instance. As may be seen from FIG. 3, the real characteristics curve has the same functionality as an ideal characteristics curve of a customary pressure regulating valve, except in the beginning region. The reason for this is especially that a steady flow has to be present for the functioning of device 1, so as to generate, in particular, cavitation regions 8, 9 in cavitation chamber 4. It should be noted in this connection that, fundamentally, a complete cutoff function is not possible, when using the device according to the exemplary embodiment and/or exemplary method of the present invention alone. The cutoff function has to take place, for instance, by a complete closing of variable throttle 5 or an additional cutoff element. On the other hand, for the functioning of device 1 according to the exemplary embodiment and/or exemplary method of the present invention and the method according to the present invention, it is necessary that a constant flow of the fluid be present to a certain extent.

However, because of the omission of moving components, the device according to the present invention demonstrates no type of restriction with respect to its dynamics. Furthermore, pressure pulsations during the regulating procedure can also be avoided.

In order to avoid possible cavitation damage because of the deliberate generation of cavitation regions 8, 9 in cavitation chamber 4, cavitation chamber 4 may be developed in such a way that the cavitation regions are at a slight clearance from the walls of the cavitation chamber.

Device 1 according to the exemplary embodiment and/or exemplary method of the present invention may be used in vehicles, especially in fuel injection or hydraulic systems, such as braking systems or drive train systems.

1-13. (canceled)

14. A device for regulating at least one of a pressure and a volume flow of a fluid, comprising:
a cavitation chamber having a ram device to generate a ram pressure region, and having at least one outlet orifice for a discharge of the fluid from the cavitation chamber; and
at least one cavitation region in the cavitation chamber being able to be generated in the cavitation chamber;
wherein the at least outlet orifice is situated so that the fluid flows between the cavitation region and the ram pressure region to the at least one outlet orifice.

15. The device of claim 14, wherein a throttle device is situated in front of the cavitation chamber in a flow direction of the fluid.

16. The device of claim 15, wherein the throttle device has a modifiable flow cross section.

17. The device of claim 14, wherein the ram device includes at least one of a domed region and a spherical segment.

18. The device of claim 14, wherein a free jet of the fluid is directed to a middle of the ram device.

19. The device of claim 14, wherein the cavitation region includes an eddy having a shear layer cavitation.

20. The device of claim 18, wherein the cavitation region includes two eddies which are situated symmetrically with respect to the free jet.

21. The device of claim 14, wherein the at least one outlet orifice includes at least two outlet orifices which are situated symmetrically with respect to the free jet in the cavitation chamber.

22. A method for regulating at least one of a pressure and a volume flow of a fluid, the method comprising:
supplying the fluid into a cavitation chamber so that a ram pressure region and at least one cavitation region are formed in the cavitation chamber, wherein the cavitation chamber includes at least one outlet orifice; and
discharging through the at least one outlet orifice the fluid supplied to the cavitation chamber, wherein the fluid flows between the cavitation region and the ram pressure region to the at least one outlet orifice, and wherein regulation occurs by a modification in at least one of (i) a size or a position of the cavitation region and (ii) a size or position of the ram pressure region.

23. The method of claim 22, wherein the ram pressure region becomes greater in response to an enlargement of a volume flow of the supplied fluid and the enlarged ram pressure region at least partially displaces the cavitation region from the at least one outlet orifice.

24. The method of claim 22, wherein a base regulating pressure is settable using an adjustable throttle device, which is situated before the cavitation chamber in the flow direction.

25. The method of claim 22, wherein at least two cavitation regions are generated in the cavitation chamber, and are symmetrical with respect to a free jet of the fluid.

26. The method of claim 22, wherein the ram pressure region is generated symmetrically with respect to the free jet.
